(19) United States
(12) Patent Application Publication
(10) Pub. No.: US 2026/0250114 A1
(43) Pub. Date: Aug. 27, 2026

(54) SEALING DEVICE

(71) Applicant: Shanghai Xinqi Electronic Technology Co., Ltd., Shanghai (CN)

(72) Inventor: Guodong Yao, Shanghai (CN)

(21) Appl. No.: 19/648,036

(22) Filed: Apr. 15, 2026

Related U.S. Application Data
(63) Continuation-in-part of application No. 18/981,706, filed on Dec. 16, 2024.
Application No. 18/981,706 is a continuation of application No. 18/624,165, filed on Apr. 2, 2024, now Pat. No. 12,209,005.
Application No. 18/624,165 is a continuation of application No. 17/944,828, filed on Sep. 14, 2022, now Pat. No. 11,981,555.

(30) Foreign Application Priority Data
Sep. 6, 2022 (CN) 202211085654.X

(51) Int. Cl. B67B 3/24

(52) U.S. Cl. CPC B67B 3/24

(57) ABSTRACT

A sealing device includes a body portion, an air extraction mechanism, and an external extraction mechanism. The body portion defines a first working chamber and a first opening formed on one side of the first working chamber. The air extraction mechanism is connected to the body portion and configured to discharge air in the first working chamber. The external extraction mechanism includes a sealing portion and an extraction portion. The sealing portion is detachably mounted to the body portion, and the extraction portion defines a second working chamber. The sealing portion is configured to close the first opening, enabling the second working chamber to be communicated with the first working chamber.

### CROSS REFERENCE TO RELATED APPLICATIONS

This application is a continuation-in-part of the U.S. application Ser. No. 18/981,706, filed on Dec. 16, 2024. U.S. application Ser. No. 18/981,706 is a continuation application of the U.S. application Ser. No. 18/624,165, filed on Apr. 2, 2024, which is a continuation application of the U.S. patent application Ser. No. 17/944,828, filed on Sep. 14, 2022, which claims priority to Chinese Patent Application No. 202211085654.X, filed on Sep. 6, 2022, the contents of which are herein incorporated by reference in their entireties.

### FIELD OF THE DISCLOSURE

The present disclosure relates to the field of home appliance technology, and in particular, to a sealing device.

### BACKGROUND

Existing vacuum sealing devices are widely used in fields such as food preservation and item storage. An air extraction mechanism is used to extract air from inside a container, thereby forming a negative pressure environment to extend a preservation time of items or achieve sealed storage.

However, vacuum sealing devices in the prior art are typically designed for containers with a specific structure, being only suitable for containers with a single size of a jar mouth, or only applicable to one type of container. In actual use, types of objects that can be evacuated to form a vacuum-sealed environment are relatively limited. For different containers, users need to prepare multiple matching sealing devices, which not only increases a cost of use but is also inconvenient to use.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a sealing device is provided. The sealing device includes a body portion, an air extraction mechanism, and an external extraction mechanism. The body portion defines a first working chamber and a first opening formed on one side of the first working chamber. The air extraction mechanism is connected to the body portion and configured to discharge air in the first working chamber. The external extraction mechanism includes a sealing portion and an extraction portion. The sealing portion is detachably mounted to the body portion, and the extraction portion defines a second working chamber. The sealing portion is configured to close the first opening, enabling the second working chamber to be communicated with the first working chamber.

### BRIEF DESCRIPTION OF THE DRAWINGS

Illustrative embodiments of the present disclosure are described in detail below with reference to the attached drawing figures.

FIG. 1 is a schematic view of an overall structure of a sealing device according to embodiments of the present disclosure.

FIG. 2 is a schematic view of a detachable connection structure between an external extraction mechanism and a body portion according to embodiments of the present disclosure.

FIG. 3 is a cross-sectional view of the body portion according to embodiments of the present disclosure.

FIG. 4 is an exploded view of the external extraction mechanism according to embodiments of the present disclosure.

FIG. 5 is a structural view of the sealing device showing the external extraction mechanism directly connected to the body portion and directly sealing a first opening according to embodiments of the present disclosure.

FIG. 6 is a first structural view of the body portion and an adapter according to embodiments of the present disclosure.

FIG. 7 is a second structural view of the body portion and the adapter according to embodiments of the present disclosure.

FIG. 8 is a structural view of the sealing device showing the external extraction mechanism mounted to the body portion via the adapter according to embodiments of the present disclosure.

FIG. 9 is a schematic view of an internal structure of the body portion according to embodiments of the present disclosure, showing an outer shell and an inner shell.

FIG. 10 is a schematic view of a usage state in which the body portion directly seals a Mason jar with a large opening diameter according to embodiments of the present disclosure.

FIG. 11 is a schematic view of a usage state in which the adapter seals a Mason jar with a small opening diameter according to embodiments of the present disclosure.

### NUMERAL REFERENCE IN THE DRAWINGS

1—body portion; 101—first working chamber; 102—first opening; 103—extraction hole; 104—air inlet hole; 11—housing; 12—control board; 13—light emitting member; 14—light guide member; 15—battery; 16—operation panel; 110—mounting cavity; 111—top face of housing; 112—light transmission hole; 1101—outer shell; 1102—inner shell;
2—air Extraction Mechanism;
3—external extraction mechanism; 31—sealing portion; 32—extraction portion; 33—flexible connecting tube; 311—closing plate; 312—engaging cylinder; 313—limiting platform; 3120—inner cavity; 3121—first through hole; 3122—first connecting boss; 321—second connecting boss; 3201—second working chamber; 3202—second through hole; 331—first end of flexible connecting tube; 332—second end of flexible connecting tube;
4—adapter; 401—third working chamber; 402—third opening; 403—vent hole;
5—first sealing ring; 51—top connecting portion; 52—first side wall; 53—second side wall;
6—second sealing ring.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

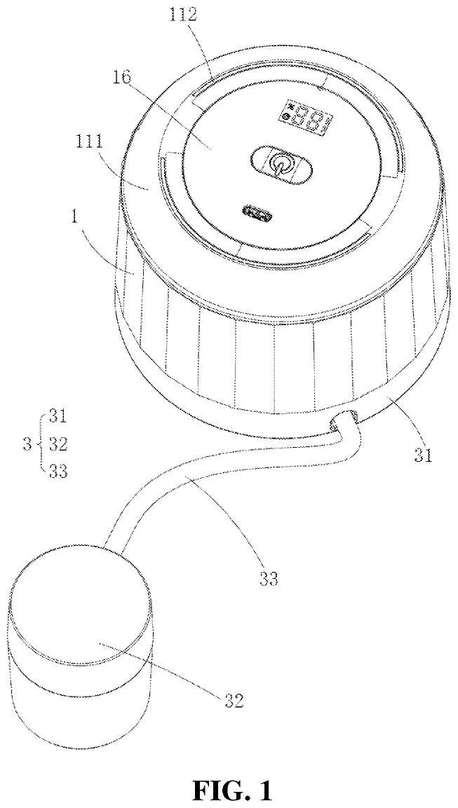

Referring to FIGS. 1 to 11, the present disclosure provides a sealing device, including a body portion 1, an air extraction mechanism 2, and an external extraction mechanism 3.

A first working chamber 101 and a first opening 102 may be formed in the body portion 1, and the first opening 102 may be formed on one side of the first working chamber 101. The air extraction mechanism 2 may be connected to the body portion 1. The air extraction mechanism 2 may be specifically a vacuum pump, which may be arranged independently of the body portion 1 or arranged in the body portion 1, and may be used for discharging air in the first working chamber 101. The external extraction mechanism 3 may include a sealing portion 31 and a extraction portion 32. The sealing portion 31 may be detachably mounted to the body portion 1. The extraction portion 32 may define a second working chamber 3201. The sealing portion 31 can cover the first opening 102 so as to enable the second working chamber 3201 to be communicated with the first working chamber 101.

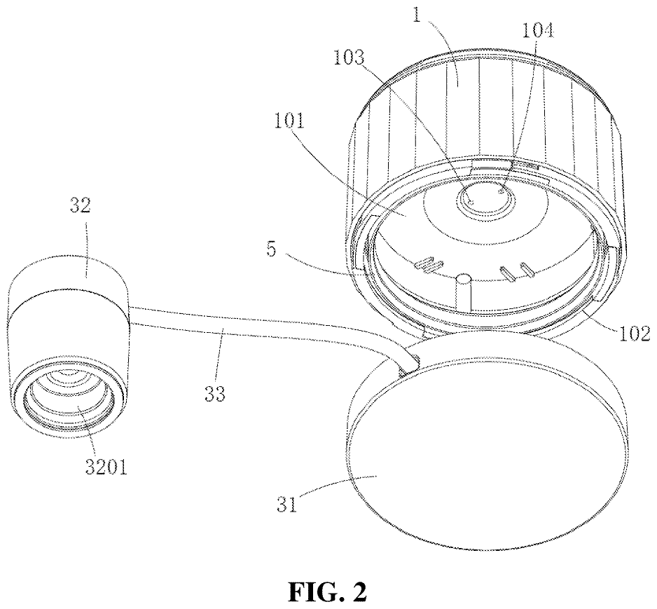

It can be understood that, as shown in FIG. 2, an extraction hole 103 and an air inlet hole 104 may be formed on an inner wall of the first working chamber 101. The extraction hole 103 may be communicated to the vacuum pump via a pipeline, while the air inlet hole 104 may be communicated to a valve body, which can open or close a communication between the air inlet hole 104 and an outside of the sealing device. The valve body may be a solenoid valve, not shown in the drawings. When the vacuum pump is started, the solenoid valve may be in a closed state, so that a negative pressure may be generated in the first working chamber 101; when the vacuum pump stops and the solenoid valve is opened, external air may quickly enter the first working chamber 101 through the air inlet hole 104 to achieve a pressure balance.

The body portion 1 may be injection molded using engineering plastics such as ABS or PC to ensure a structural strength. An inner wall of the body portion 1 may enclose to form the first working chamber 101, and the first opening 102 may be formed on a lower side of the first working chamber 101.

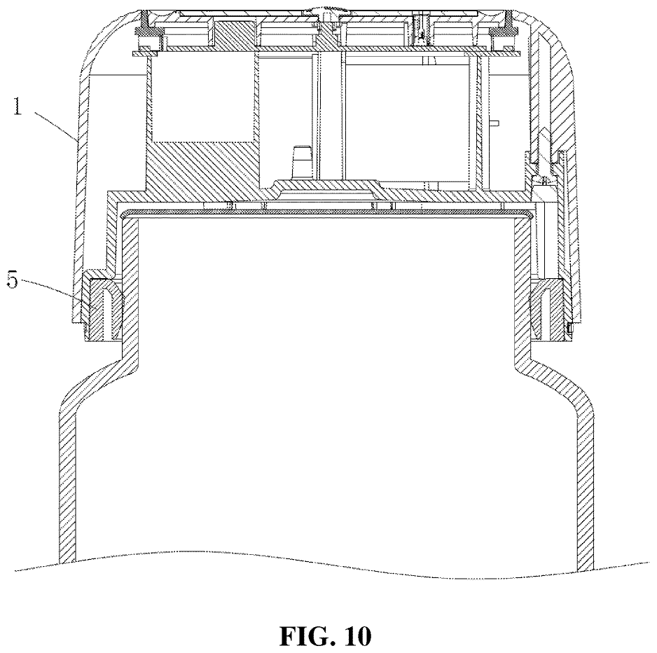

When the body portion 1 is used to seal a container, the container may be placed with a lid of the container inserted into the first working chamber 101 from the first opening 102, a mouth of the container inserted into the first working chamber 101 from the first opening 102, and the mouth pressed against the lid. When the air extraction mechanism 2 is started, air inside the first working chamber 101 may be evacuated. Due to a negative pressure environment in the first working chamber 101, an external atmosphere may force the container to be pressed into the first working chamber 101, so that the mouth of the container may tightly abut against the lid. At the same time, because of the negative pressure environment in the first working chamber 101, the air inside the container may be also evacuated, and a negative pressure environment may also be formed inside the container, causing the lid to be continuously adsorbed onto the mouth, as shown in FIG. 10. An outer wall of the container mouth may need to tightly abut against the inner wall of the first working chamber 101 to ensure sealing of the first working chamber 101 when the air extraction mechanism 2 is operating, preventing the air extraction mechanism 2 from directly drawing in external air. This can be achieved by arranging a first sealing ring 5 on the inner wall of the first working chamber 101 to achieve sealing between the outer wall of the mouth of the container and the inner wall of the first working chamber 101. Both the sealing portion 31 and the mouth of the container can be maintained on the body portion 1 by a frictional force with the first sealing ring 5.

The external extraction mechanism 3 may be detachably mounted to the body portion 1. The external extraction mechanism 3 may extend an extraction capability of the body portion 1 to different objects to be extracted. When the external extraction mechanism 3 is mounted to the body portion 1, the negative pressure environment in the first working chamber 101 may extend into the second working chamber 3201 inside the extraction portion 32. A shape of the extraction portion 32 may be arranged to correspond to other types of containers, allowing the user to seal other types of containers through the extraction portion 32.

For example, the first working chamber 101 formed on the body portion 1 may be adapted for sealing Mason jars, while the extraction portion 32 may be adapted for sealing vacuum packaging bags. When the external extraction mechanism 3 is detached from the body portion 1, the body portion 1 can seal the Mason jar; when the external extraction mechanism 3 is mounted to the body portion 1, the external extraction mechanism 3 may evacuate and seal the vacuum packaging bag.

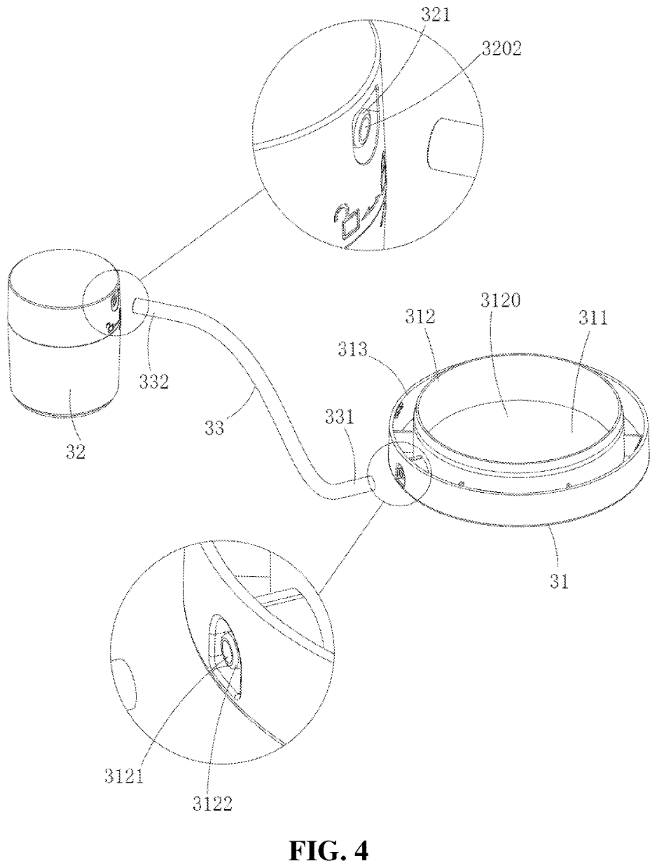

Regarding a specific structure of the external extraction mechanism 3, referring to FIGS. 2 and 4, in some embodiments, the sealing portion 31 may include a closing plate 311 and an engaging cylinder 312 formed on the closing plate 311. The engaging cylinder 312 and the closing plate 311 enclose to cooperatively form an inner cavity 3120. A first through hole 3121 may be formed on an inner wall of the engaging cylinder 312, the first through hole 3121 is communicated with each of the first working chamber 101 and the second working chamber 3201. The engaging cylinder 312 may extend into the first working chamber 101 from the first opening 102 so as to communicate the first working chamber 101 with the inner cavity 3120, and the closing plate 311 can seal the first opening 102. The engaging cylinder 312 may extend into the first working chamber 101 from the first opening 102, enabling self-positioning and limiting radial displacement during mounting, ensuring alignment between the closing plate 311 and the first opening 102, thereby allowing the closing plate 311 to reliably cover the first opening 102 and block external air leakage paths.

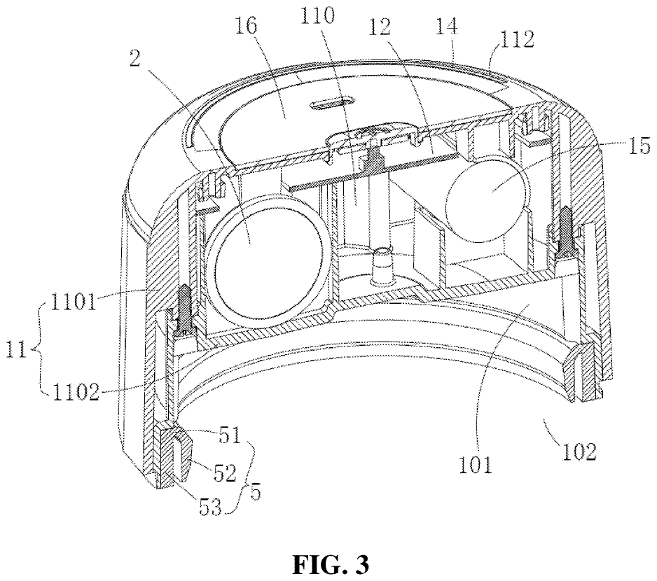

Referring to FIG. 3, the aforementioned first sealing ring 5 may be located in the first working chamber 101 and may be arranged surrounding the first opening 102, so that the engaging cylinder 312 may be in close contact with the first sealing ring 5. The first sealing ring 5 can be formed from a material such as silicone or rubber. The first sealing ring 5 may provide elastic compression and gap compensation, forming an annular sealing band between the engaging cylinder 312 and an area of the body portion 1 at the first opening 102, avoiding air leakage caused by assembly tolerances or stress deformation.

Furthermore, referring to FIG. 4, the sealing portion 31 may further include a limiting platform 313 formed on the closing plate 311. The limiting platform 313 may abut against the body portion 1, and the first sealing ring 5 may be arranged between the limiting platform 313 and the engaging cylinder 312. The limiting platform 313 may contact the body portion 1 and provide a mounting positioning, preventing assembly deviation of the sealing portion 31. The first sealing ring 5 may be arranged between the limiting platform 313 and the engaging cylinder 312, allowing the first sealing ring 5 to obtain a stable compression amount under a restriction of the limiting platform 313, making a stress on the first sealing ring 5 more uniform and maintaining an elastic sealing state for a long time, thereby further reducing a probability of air leakage and improving repeated assembly reliability.

In some embodiments, referring to FIGS. 3, 5, and 8, a cross-section of the first sealing ring 5 may be in an inverted “U” shape. The first sealing ring 5 with an inverted “U” shaped cross-section may include a top connecting portion 51, and a first side wall 52 and a second side wall 53 which may extend downward from the top connecting portion 51. A receiving groove may be formed between the first side wall 52 and the second side wall 53. The first side wall 52 may contact the mouth of the container, while the receiving groove can provide a deformation space for the first side wall 52 during container assembly. The mouth of the container may be sealed by a deformation of the first side wall 52. During the deformation of the first side wall 52, the second side wall 53 may be not affected, thereby reducing a risk of leakage caused by assembly deviation, vibration, or thermal expansion/contraction of the material, ensuring a sealing performance of the first sealing ring 5.

In some embodiments, referring to FIG. 4, the sealing portion 31 may further include a first connecting boss 3122 formed on the engaging cylinder 312, and the first through hole 3121 may penetrate through the first connecting boss 3122. The extraction portion 32 may be arranged with a second connecting boss 321. An inner wall of the second working chamber 3201 may define a second through hole 3202, and the second through hole 3202 may penetrate through the second connecting boss 321. The external extraction mechanism 3 may further include a flexible connecting tube 33. A first end 331 of the flexible connecting tube 33 may be fitted over the first connecting boss 3122, and a second end 332 of the flexible connecting tube 33 may be fitted over the second connecting boss 321, so that the first through hole 3121 may be communicated with the second through hole 3202.

The first connecting boss 3122 may be integrally injection molded or integrally die-cast with the engaging cylinder 312 as a one-piece structure. Integral formation can reduce the number of assembly parts and lower a risk of air leakage. The first through hole 3121 may penetrate through the first connecting boss 3122, can output negative pressure from the first working chamber 101 through the first connecting boss 3122 to the flexible connecting tube 33. The second connecting boss 321 may cooperate with the flexible connecting tube 33, achieving a gas path communication between the first working chamber 101 and the second working chamber 3201.

The flexible connecting tube 33 can be made of silicone tube, TPU tube, or PVC hose. The flexible connecting tube 33 may establish a bendable and deformable gas path communication between the sealing portion 31 and the extraction portion 32, so that a position of the extraction portion 32 may be adjusted relative to the sealing portion 31. When necessary, a clamp or elastic binding ring may be arranged at an end of the flexible connecting tube 33. The clamp or elastic binding ring may further improve sealing reliability and prevent loosening of the flexible connecting tube 33 after prolonged use. Through the above connection relationship, the first through hole 3121 and the second through hole 3202 may be communicated with each other by the flexible connecting tube 33, so that the negative pressure generated by the body portion 1 can be stably transmitted to the second working chamber 3201, thereby completing a vacuum extraction for other containers.

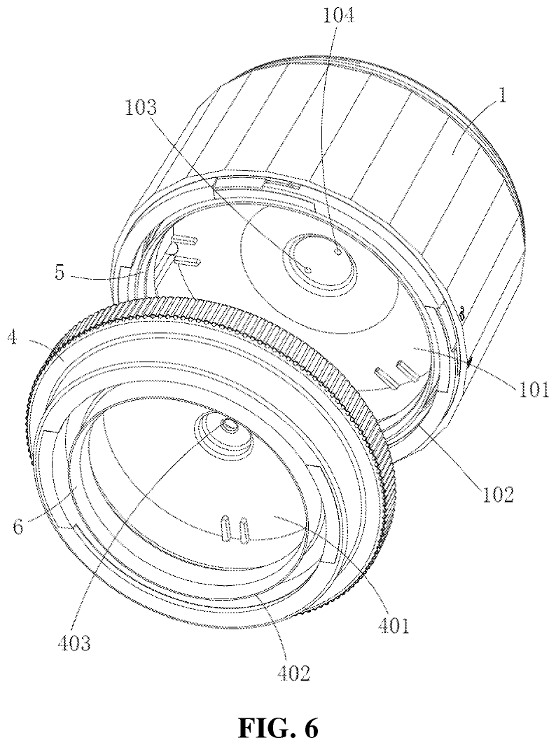

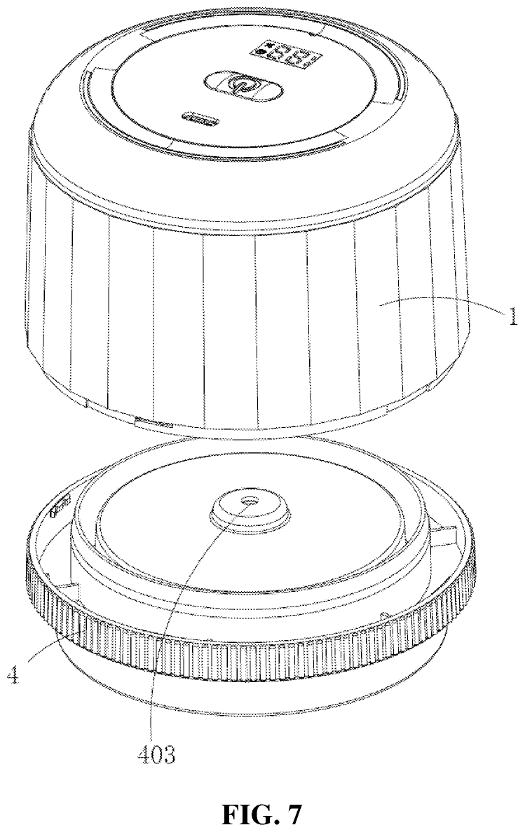

To improve an adaptability of the sealing device to containers of different styles and specifications, referring to FIGS. 6 and 7, in some embodiments, the sealing device may further include an adapter 4. The adapter 4 may define a third working chamber 401 and a third opening 402 on a side of the third working chamber 401. The adapter 4 may be detachably mounted to the body portion 1. When the adapter 4 is mounted to the body portion 1, the third working chamber 401 and the first working chamber 101 may be communicated with each other, and the first opening 102 may be closed by the adapter 4. That is, after the air extraction mechanism 2 is started, both the third working chamber 401 and the first working chamber 101 may be under negative pressure.

An opening diameter of the third opening 402 may be different from an opening diameter of the first opening 102, so that the body portion 1 can seal a container with a large opening diameter, while the adapter 4 can seal a container with a small opening diameter. Taking sealing Mason jars as an example, the first opening 102 may correspond to a large-mouth Mason jar, and the third opening 402 may correspond to a small-mouth Mason jar.

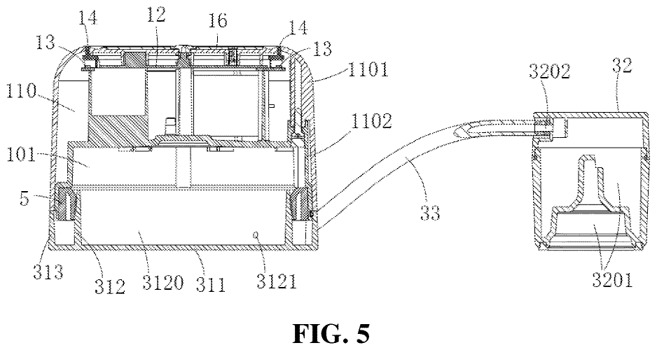

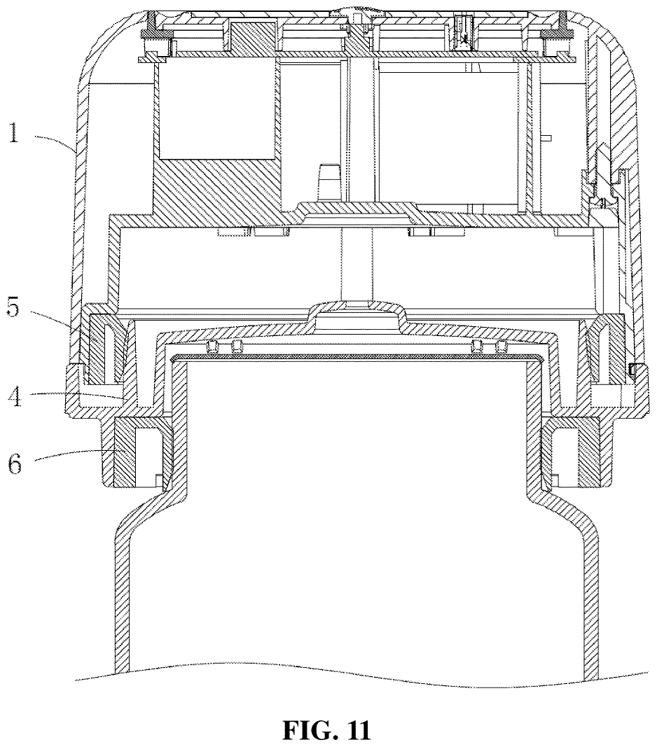

When one of the adapter 4 and the external extraction mechanism 3 is mounted on the body portion 1, the other of the adapter 4 and the external extraction mechanism 3 may be separated from the body portion 1. That is, when the aforementioned external extraction mechanism 3 needs to be used, the adapter 4 may first be removed from the body portion 1, and then the sealing portion 31 may be mounted to the body portion 1, ultimately resulting in a usage state shown in FIG. 5. Conversely, when the adapter 4 needs to be used, the sealing portion 31 may first be separated from the body portion 1, ultimately resulting in a usage state shown in FIG. 11. In this embodiment, an outer diameter of the engaging cylinder 312 of the sealing portion 31 may be adapted to an inner diameter of the first opening 102.

Additionally, a second sealing ring 6 may be arranged. The second sealing ring 6 may be adaptably mounted in the third working chamber 401, used to form a sealing between an outer wall of the mouth of the container with a small opening diameter and the inner wall of the third working chamber 401. Furthermore, when the adapter 4 is mounted to the body portion 1, a top portion of the adapter 4 may extend to the first working chamber 101, and a vent hole 403 may be formed at a top portion of the adapter 4 to communicate the first working chamber 101 and the third working chamber 401. The aforementioned first sealing ring 5 can also ensure a sealing of the connection between the adapter 4 and the body portion 1. A shape of the second sealing ring 6 may be the same as the shape of the first sealing ring 5.

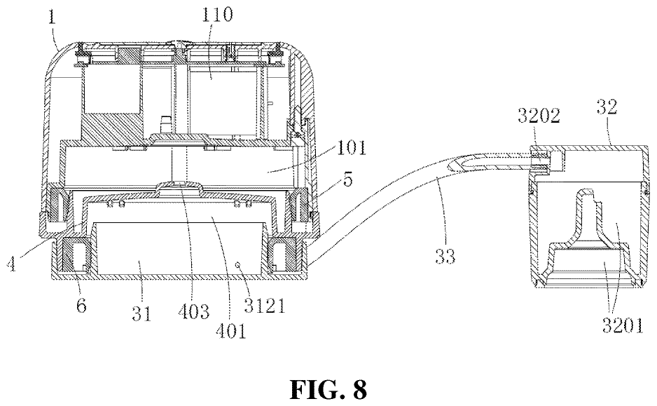

In the previous embodiment, the external extraction mechanism 3 may be detachably mounted to the body portion 1. In other embodiments, as shown in FIG. 8, the external extraction mechanism 3 may also be detachably mounted to the adapter 4. In these other embodiments, the body portion 1 and the adapter 4 may be arranged in a same way as in the previous embodiment. The difference lies in that, in these other embodiments, the external extraction mechanism 3 may be detachably mounted to the adapter 4, so that the external extraction mechanism 3 may be connected to the body portion 1 via the adapter 4. When the sealing portion 31 of the external extraction mechanism 3 is mounted to the adapter 4, the sealing portion 31 may close the third opening 402, ultimately sealing an entirety of the first working chamber 101 and the third working chamber 401. In these other embodiments, a usage scenario of the external extraction mechanism 3 may be based on the premise that the adapter 4 is already mounted to the body portion 1. In this case, the adapter 4 may be merely used as an intermediate connecting member and may not need to be removed from the body portion 1. In these other embodiments, an outer diameter of the engaging cylinder 312 of the sealing portion 31 may be matched with an inner diameter of the third opening 402.

It can be understood that, in the above two embodiments, a detachable connection structure between the body portion 1 and the adapter 4 can be specifically achieved by means of threads, snap fasteners, bolted connections, or the like.

Also for a purpose of improving an adaptability of the sealing device to containers of different styles and specifications, in some embodiments, the extraction portion 32 may also be used to evacuate containers of various opening diameters. Similarly, the extraction portion 32 can also be split by referring to an allocation manner of the body portion 1 and the adapter 4, allowing the extraction portion 32 to be adapted to two types of containers.

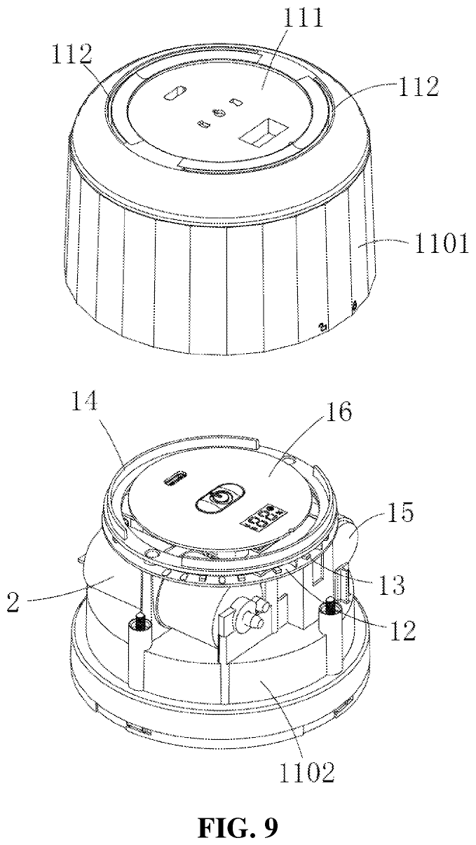

To facilitate the user in distinguishing a current working state of the sealing device, in some embodiments, referring to FIGS. 3 and 9, the body portion 1 may include a housing 11, a control board 12, a light emitting member 13, and a battery 15. A mounting cavity 110 may be formed in the housing 11. The air extraction mechanism 2, the control board 12, the battery 15, and the light emitting member 13 may be all arranged in the mounting cavity 110. The control board 12 may be electrically connected to each of the light emitting member 13 and the air extraction mechanism 2. The light emitting member 13 may transmit light from a top face 111 of the housing 11. Depending on a working state of the air extraction mechanism 2 or a charging state of the battery 15, the control board 12 can cause the light emitting member 13 to generate different light signals. For example, when the air extraction mechanism 2 is working, the light emitting member 13 may continuously emit green light; when the battery 15 is charging, the light emitting member 13 may emit flashing red light.

To expand a light emission area and improve a light emission uniformity, in some embodiments, the body portion 1 may further include a light guide member 14. The top face 111 of the housing 11 may define a light transmission hole 112. The light guide member 14 may be arranged in the mounting cavity 110 and partially exposed from the light transmission hole 112. The light guide member 14 may be arranged between the light emitting member 13 and the light transmission hole 112. The light emitting member 13 may include a plurality of lamp beads integrated on the control board 12. A light generated by the lamp beads may be evenly diffused through the light guide member 14, achieving a defined shape of light emission.

In some embodiments, the body portion 1 may further include an operation panel 16. The operation panel 16 may be mounted to the top face 111 of the housing 11. The light transmission hole 112 may be arranged in a ring shape surrounding the operation panel 16. The light guide member 14 may close the light transmission hole 112. When the user operates the operation panel 16, an effect may be very noticeable when the light guide member 14 arranged around the operation panel 16 emits light.

Regarding a structure of the housing 11, in some embodiments, the housing 11 may include an outer shell 1101 and an inner shell 1102. A mounting cavity 110 may be formed in the outer shell 1101. The air extraction mechanism 2, the battery 15, and the control board 12 may be all arranged in the mounting cavity 110. The inner shell 1102 closes the mounting cavity 110. Furthermore, the air extraction mechanism 2, the battery 15, and the control board 12 may all be mounted on a side of the inner shell 1102 facing the mounting cavity 110. The inner shell 1102 may specifically be fixed to the outer shell 1101 by bolts. The aforementioned first working chamber 101 and first opening 102 may both be formed on a side of the inner shell 1102 facing away from the mounting cavity 110.

By providing the external extraction mechanism 3 detachable from the body portion 1, at least two options, namely, extraction via the body portion or extraction via the external extraction mechanism 3 can be achieved, thereby expanding a range of adaptable objects and improving usage flexibility of the sealing device. This single sealing device can adapt to at least two types of extraction objects, making the sealing device more convenient for users.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

What is claimed is:

1. A sealing device, comprising:
a body portion, defining a first working chamber and a first opening formed on one side of the first working chamber;
an air extraction mechanism, connected to the body portion and configured to discharge air in the first working chamber; and
an external extraction mechanism, comprising a sealing portion and an extraction portion, wherein the sealing portion is detachably mounted to the body portion, and the extraction portion defines a second working chamber; the sealing portion is configured to close the first opening, enabling the second working chamber to be communicated with the first working chamber.

2. The sealing device according to claim 1, wherein the sealing portion comprises a closing plate and an engaging cylinder formed on the closing plate, and the engaging cylinder and the closing plate cooperatively define an inner cavity; the engaging cylinder defines a first through hole, and the first through hole communicates the first working chamber and the second working chamber;
the engaging cylinder is configured to extend into the first working chamber from the first opening, enabling the first working chamber to be communicated with the inner cavity and the closing plate to seal the first opening.

3. The sealing device according to claim 2, further comprising a first sealing ring, wherein the first sealing ring is arranged in the first working chamber and is arranged surrounding the first opening; the engaging cylinder is in close contact with the first sealing ring.

4. The sealing device according to claim 3, wherein the sealing portion further comprises a limiting platform formed on the closing plate, the limiting platform is configured to abut against the body portion, and the first sealing ring is arranged between the limiting platform and the engaging cylinder.

5. The sealing device according to claim 3, wherein a cross-section of the first sealing ring is in an inverted “U” shape.

6. The sealing device according to claim 2, wherein the sealing portion further comprises a first connecting boss formed on the engaging cylinder, and the first through hole is formed penetrating through the first connecting boss;
the extraction portion is arranged with a second connecting boss, an inner wall of the second working chamber defines a second through hole, and the second through hole is formed penetrating through the second connecting boss;
the external extraction mechanism further comprises a flexible connecting tube, a first end of the flexible connecting tube is fitted over the first connecting boss, and a second end of the flexible connecting tube is fitted over the second connecting boss, enabling the first through hole to be communicated with the second through hole.

7. The sealing device according to claim 1, further comprising an adapter, wherein the adapter defines a third working chamber and a third opening on one side of the third working chamber; the adapter is detachably mounted to the body portion, enabling the third working chamber to be communicated with the first working chamber, and when the adapter is mounted to the body portion, the adapter closes the first opening;
an opening diameter of the third opening is different from an opening diameter of the first opening;
when one of the adapter and the external extraction mechanism is mounted to the body portion, and the other of the adapter and the external extraction mechanism is separated from the body portion.

8. The sealing device according to claim 1, further comprising an adapter, wherein the adapter defines a third working chamber and a third opening on one side of the third working chamber; the adapter is detachably mounted to the body portion, enabling the third working chamber to be communicated with the first working chamber, and when the adapter is mounted to the body portion, the adapter closes the first opening;
an opening diameter of the third opening is different from an opening diameter of the first opening;
the external extraction mechanism is detachably mounted to the adapter, enabling the external extraction mechanism to be connected with the body portion via the adapter; when the sealing portion of the external extraction mechanism is mounted to the adapter, the sealing portion closes the third opening.

9. The sealing device according to claim 1, wherein the body portion comprises a housing, a control board, and a light emitting member; a mounting cavity is formed in the housing, and each of the control board and the light emitting member is arranged in the mounting cavity; the control board is electrically connected to each of the light emitting member and the air extraction mechanism, and the light emitting member transmits light from a surface of the housing.

10. The sealing device according to claim 9, wherein the body portion further comprises a light guide member, a top face of the housing defines a light transmission hole, the light guide member is arranged in the mounting cavity and partially exposed in the light transmission hole, and the light guide member is arranged between the light emitting member and the light transmission hole.

11. The sealing device according to claim 10, wherein the body portion further comprises an operation panel, the operation panel is mounted on the top face of the housing, the light transmission hole is formed in a ring shape surrounding the operation panel, and the light guide member closes the light transmission hole.

12. The sealing device according to claim 1, wherein the body portion comprises a housing and a control board, the housing comprises an outer shell and an inner shell, a mounting cavity is formed in the outer shell, each of the control board and the air extraction mechanism is arranged in the mounting cavity, and the control board is electrically connected to the air extraction mechanism; the inner shell closes the mounting cavity, and each of the first working chamber and the first opening is arranged on a side of the inner shell facing away from the mounting cavity.
